(19) United States
(12) Patent Application Publication
(10) Pub. No.: US 2013/0206255 A1
(43) Pub. Date: Aug. 15, 2013

(54) HYDRAULIC LOW-PASS FILTER FOR PRESSURE SENSORS

(71) Applicant: Richard John Helgeson, Soldiers Grove, WI (US)

(72) Inventor: Richard John Helgeson, Soldiers Grove, WI (US)

(73) Assignee: Caterpillar Global Mining LLC

(21) Appl. No.: 13/397,494

(22) Filed: Feb. 15, 2012

(51) Int. Cl. F16K 21/04

(52) U.S. Cl. 137/511

(57) ABSTRACT

One embodiment relates to a hydraulic low-pass filter for a pressure sensor. The hydraulic low-pass filter includes a housing having an inlet and an internal fluid chamber configured to be filled with hydraulic fluid, the fluid chamber connected to a pressure sensor. The hydraulic low-pass filter further includes an adjustable flow restriction member provided between the inlet and the pressure sensor; and a compliant member provided within the chamber. A cut-off frequency of the low-pass filter is a function of a size of a flow restriction applied by the flow restriction member and a compliance of the compliant member.

### BACKGROUND

The present disclosure relates generally to the field of hydraulic systems. More specifically, the present disclosure relates to a low-pass filter for a hydraulic system to reduce high frequency noise in a hydraulic circuit and protect sensitive components from transient high pressure spikes (e.g., shockwaves, pulses, surges, etc.).

High pressure spikes can be created in hydraulic systems as a result of a release of stored pressure or a sudden change in momentum of the fluid in the system. For example, high pressure spikes may result from valves opening and closing or from a sudden change in the load being driven by a hydraulic cylinder.

Pressure sensors are often transducers that translate a change in pressure to a change in output voltage that is communicated to a control system. Electronic or digital filters may be utilized to filter out pressure spikes sensed by the pressure sensor; however, the extreme pressures cause the sensor to become saturated and a time period is required for the sensor to recover from the saturation. During the saturation and recovery time, the pressure sensor is unable to output valid pressure readings to the control system. Further, electronic filtering of the resulting sensor output does nothing to protect the sensor itself from physical damage that may result from exposure to excessive transient pressures.

### SUMMARY

One embodiment relates to a hydraulic low-pass filter for a pressure sensor. The hydraulic low-pass filter includes a housing having an inlet and an internal fluid chamber configured to be filled with hydraulic fluid, the fluid chamber connected to a pressure sensor. The hydraulic low-pass filter further includes an adjustable flow restriction member provided between the inlet and the pressure sensor; and a compliant member provided within the chamber. A cut-off frequency of the low-pass filter is a function of a size of a flow restriction applied by the flow restriction member and a compliance of the compliant member.

Another embodiment relates to an in-line low-pass filter for a hydraulic pressure sensor. The filter includes a housing having an inlet and an internal fluid chamber filled with hydraulic fluid, the fluid chamber connected to a pressure sensor. The filter further includes a flow restriction member provided between the inlet and the pressure sensor, and a compliant member provided within the chamber. The low-pass filter is configured to filter high frequency noise and transient pressure spikes associated with a hydraulic device.

Still another embodiment relates to a hydraulic system for mining equipment. The hydraulic system includes a hydraulic device and a conduit containing hydraulic fluid coupled to the hydraulic device. The system further includes a hydraulic pressure sensor configured to sense the pressure of the fluid contained within the conduit and a low-pass filter disposed between the pressure sensor and the conduit. The low pass filter includes a housing having an inlet and an internal fluid chamber filled with hydraulic fluid, the fluid chamber connected to the pressure sensor; a flow restriction member provided between the inlet and the pressure sensor; and a compliant member provided within the chamber. The low-pass filter is configured to a filter high frequency noise and transient pressure spikes associated with the hydraulic device.

Alternative exemplary embodiments relate to other features and combinations of features as may be generally recited in the claims.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a schematic block diagram of a hydraulic system, in accordance with an exemplary embodiment.

FIG. 2 is a schematic cross-section view of a low-pass filter for a hydraulic system, in accordance with an exemplary embodiment.

FIG. 3A is an unfiltered pressure profile for a hydraulic system.

FIG. 3B is a pressure profile for a hydraulic system after passing through a low-pass filter, in accordance with an exemplary embodiment.

FIG. 3C is a pressure profile for a hydraulic system after passing through a pressure snubber.

FIG. 4 is a schematic cross-section view of a low-pass filter for a hydraulic system, in accordance with another exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

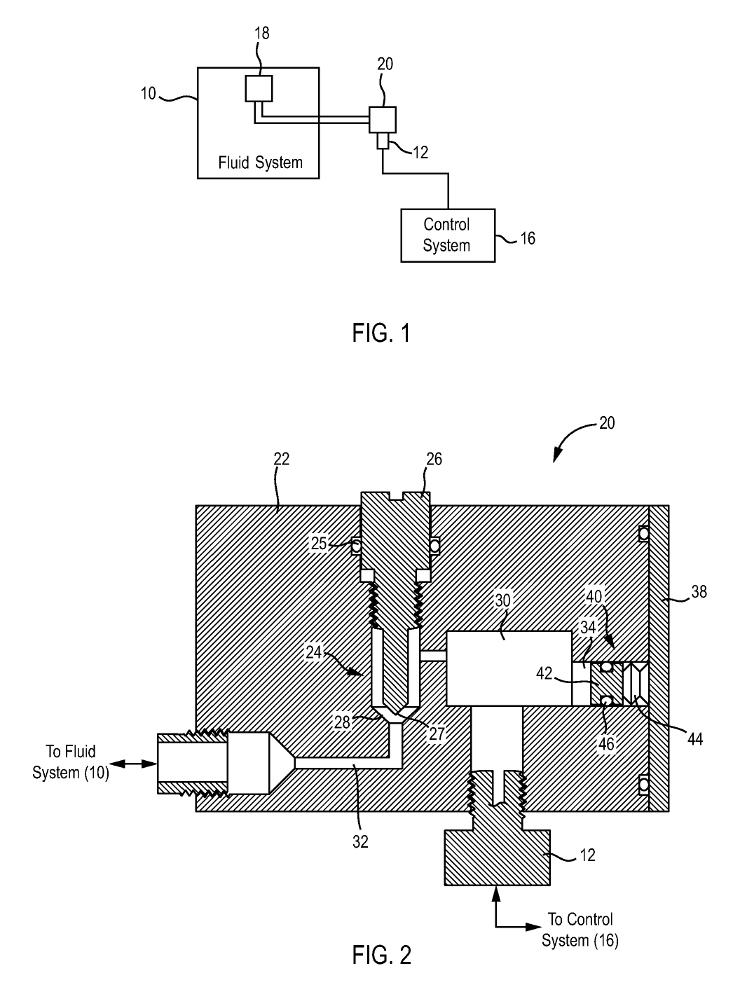

Referring to FIG. 1, a portion of a hydraulic system 10 is shown schematically. The hydraulic system 10 includes one or more hydraulic devices 18 (e.g., valves, hydraulic cylinder, hydraulic pumps, etc.). A pressure sensor 12 (e.g., pressure transducer) is provided to monitor the pressure of the hydraulic fluid utilized in the system 10 to operate the hydraulic devices 18. The pressure sensor 12 converts pressure into an analog electrical signal. According to one exemplary embodiment, the pressure sensor 12 is a strain-gage based transducer with a strain gage coupled to a flexible diaphragm between the hydraulic fluid to be sensed and a fluid at a known pressure, such as air at atmospheric pressure. A pressure differential causes a physical deformation of the diaphragm and introduces strain to the gages. The strain produces an electrical resistance change proportional to the pressure. The variable resistance may then be utilized to output a variable voltage to be analyzed by a control system 16.

A high pressure surge can generate a large amount of energy over a very short time period. Such a transient pulse or wave of pressure can saturate and damage components of the pressure sensor 12 such as the flexible diaphragm of a strain gage-based transducer. Further, high frequency noise may be generated by hydraulic pumps or the high frequency component of a sudden change in system pressure. A low-pass filter 20 is therefore provided between the hydraulic fluid system 10 and the pressure sensor 12 to shield the pressure sensor 12 from hydraulic high pressure spikes and filter out or substantially eliminate high frequency noise. According to an exemplary embodiment, the filter 20 includes a flow restriction member 24, a fluid-filled communicating chamber 30, and a compliant member 40.

The flow restriction member 24 dissipates high pressure shockwaves in the fluid system 10 before they reach the pressure sensor 12. The flow restriction member 24 is shown in FIG. 2 as an adjustable flow control valve including an adjustable valve member 26 (e.g., plug, plunger, etc.) and a seat 28 formed in the housing or body 22 of the filter 20. The valve member 26 is moveable relative to the seat 28 to selectively apply a specific amount of restriction to a fluid passage 32 between the hydraulic fluid system 10 and the communicating chamber 30. According to an exemplary embodiment, the valve member is coupled to the body 22 with a threaded connection. A sealing member such as an o-ring 25 may be provided between the valve member 26 and the body 22 to prevent hydraulic fluid from leaking between the valve member 26 and the body 22. The valve member 26 has a tapered, conical head 27 that is received by the similarly tapered seat 28. As the valve member 26 is rotated relative to the body 22, the conical head 27 is advanced towards or withdrawn from the seat 28, thereby increasing or decreasing the cross-sectional area of the passage 32.

While the flow restriction device 24 is shown in FIG. 2 as a plug valve, in other embodiments, the flow restriction device may be another type of suitable valve apparatus. An adjustable flow control valve as described above is able to be adjusted to change the performance of the filter 20. Adjustment of the flow restriction device 24 allows adjustment of the cut-off frequency at which hydraulic system noise attenuation begins. The flow restriction device 24 may be installed and adjusted to adapt to a wide variety of applications. In other embodiments, the flow restriction device may be another device that advantageously restricts flow, such as a porous medium (e.g., a sintered metallic filter), a small diameter bore or passage (e.g., a fixed orifice device), or a combination of devices. Such non-adjustable devices may be utilized if the characteristics of the fluid system 10 and the cut-off frequency are well known. For example, the fluid system 10 may be known to utilize hydraulic pumps operating at 100 Hz. and the flow restriction device may be specifically configured to filter out noise at or above 100 Hz.

After passing the flow restriction device 24, pressurized fluid enters the fluid-filled communicating chamber 30 adjacent to the pressure sensor 12. As shown in FIG. 2, the compliant member 40 may be provided in a second chamber 34 adjacent to the fluid-filled communicating chamber 30, with the second chamber 34 being in fluid communication with the communicating chamber 30. While a single compliant member 40 is shown in FIG. 2, in other embodiments, the filter 20 may include multiple compliant members 40. In other embodiments, the second chamber 34 may be a portion or extension of the communicating chamber 30.

In one embodiment, the compliant member 40 includes a piston 42 moveable within the second chamber 34 and a biasing member 44 provided between the piston 42 and a stationary body, such as a wall 38 secured to the body 22. A sealing member such as an o-ring 46 may be provided between the piston 42 and the walls of the second chamber 34. According to an exemplary embodiment, the biasing member 44 is one or more Belleville washers. According to other exemplary embodiments, the biasing member 44 may be another device such as a wave spring, a coil spring, an elastomeric body (e.g., a piece of rubber or other deformable material), etc.

The biasing member 44 has a spring constant that is high enough such that the biasing member 44 exerts a spring force greater than the force applied to the piston 42 by the pressurized fluid. During normal operation, the biasing member 44 is compressed in proportion to the filtered pressure and the piston 42 therefore remains biased towards the communicating chamber. A pressure spike in the fluid system 10, however, overcomes the biasing member 44 and causes the piston 42 to move into the second chamber 34, compressing the biasing member 44. The effective volume of the communicating chamber 30 is therefore temporarily increased and the energy of the high pressure spike is at least partially absorbed by the compliant member 40. When the high pressure spike in the fluid subsides, the biasing member 44 is able to move the piston 42 back towards the communicating chamber 30.

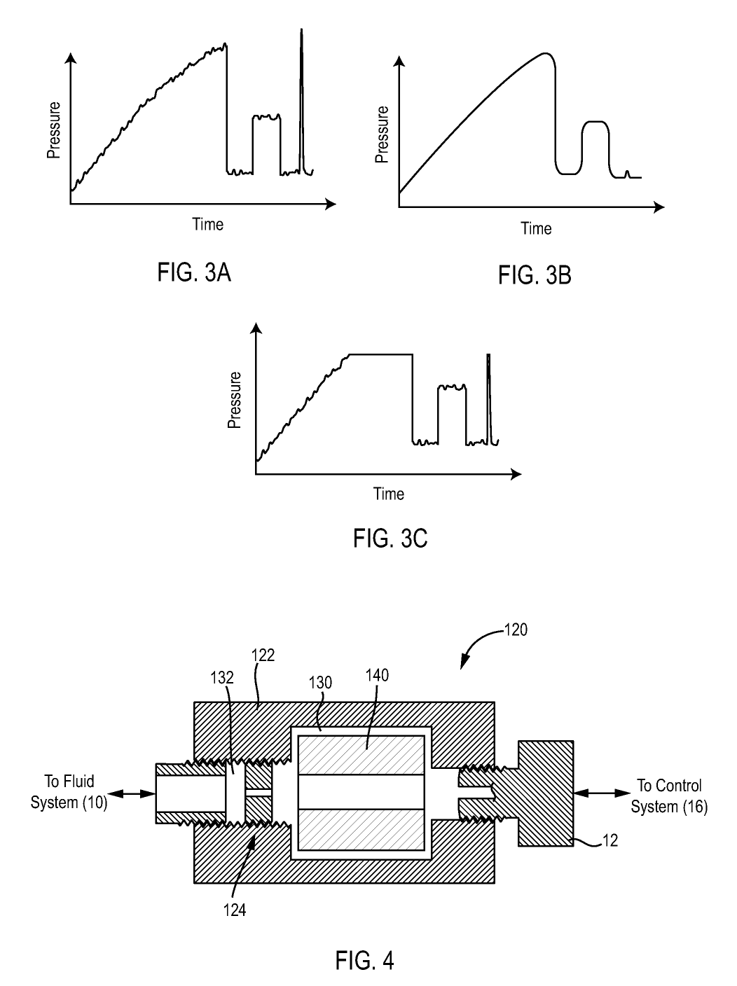

Referring now to FIGS. 3A-3B, a pressure profile for a hydraulic system is shown according to an exemplary embodiment, including a slowly increasing pressure and a transient pressure spike. FIG. 3A illustrates an unfiltered pressure to which a pressure sensor may be exposed. FIG. 3B illustrates the same pressure profile as sensed by a pressure sensor behind a low-pass filter, such as the filter 20 shown in FIG. 2. The low-pass filter substantially eliminates the high frequency noise in the hydraulic system, such as by hydraulic pumps or the high frequency component of a sudden change in system pressure. Further, the low-pass filter serves to dampen rapid increases or drop-offs in pressure, reducing sharp changes that would otherwise be experienced by the pressure sensor. As shown in FIG. 3C, a snubber, by contrast, does not filter out high frequency noise or dampen rapid changes in pressure. Instead, the snubber simply protects the pressure sensor from pressure above a predetermined threshold.

The cut-off frequency for the filter 20 is directly proportional to the compliance or resiliency of the compliant member and inversely proportional to the cross-sectional area of the flow restriction applied by the flow restriction member. Therefore, the cut-off frequency for the filter 20 may be maintained if both the compliant member 40 and the flow restriction device 24 are adjusted. This may be desirable to avoid a flow restriction that is too small and likely to be clogged by particles in the hydraulic fluid. A relatively large flow restriction (i.e., a flow restriction device adjusted to have a large flow area less susceptible to clogs) may be used in combination with a more compliant member and still achieve the desired cut-off frequency. For example, an increase in the flow area through the flow restriction device may be accompanied by an increase in the size of the compliant member (e.g., a larger volume compliant member provided in the communicating chamber (see FIG. 4), or by a decrease in the resiliency of the compliant member (e.g., decreasing the spring constant or the bulk modulus of the compliant member) to maintain the cut-off frequency of the filter.

According to an exemplary embodiment, the filter 20 utilizing the adjustable flow control valve may be calibrated in the field by changing the position of the conical head 27 relative to the tapered seat 28. The electronic output of the pressure sensor 12 may be monitored, such as with an oscilloscope. The flow restriction is adjusted by turning the valve member 26, thereby changing the ratio of flow restriction to compliance, until the high frequency oscillations in the pressure signal are eliminated. Such a calibration may be done before installation if the performance and characteristics of the hydraulic system are well known or may be calibrated in the field, after the filter 20 and pressure sensor 12 are installed in a hydraulic system.

In other exemplary embodiments, the compliant member 40 may lack a moveable member such as the piston 42 shown in FIG. 2. Instead, the second chamber 34 may be formed of an elastomeric material (e.g., an elastic hose) and may expand in the event of a pressure spike in the fluid system 10, absorbing the energy of the pressure spike.

In yet other exemplary embodiments, the second chamber 34 and/or the communicating chamber 30 may be formed by a deformable material instead of the rigid material of the main body 22 of the filter 20. For example, the communicating chamber 30 may be formed with thin, flexible walls that may be deformed to increase the volume of the communicating chamber in the event of a high pressure spike in the fluid system 10.

The flow restriction device 24, the compliant member 40 and the communicating chamber 30 cooperate to dissipate or absorb high pressure shockwaves in the hydraulic fluid of the fluid system 10 before the high pressure reaches the pressure sensor 12. The pressure sensor 12 is thereby protected from physical damage from extreme pressure spikes. The pressure sensor 12 is also able to continuously output pressure data for the fluid system 10 without breaks resulting from signal saturation and recovery periods.

Multiple pressure sensors 12 may be provided at different points to monitor the hydraulic fluid system 10. While some pressure sensors 12 may be located such that they do not experience high pressure spikes, multiple filters 20, such as shown in FIG. 2 may be provided for sensors 12 that may experience high pressure spikes during the operation of the fluid system 10.

Referring now to FIG. 4, in another embodiment, a filter 120 may include a compliant member 140 that is provided within a communicating chamber 130 formed within a body 122. For example, the compliant member 140 may be a body formed of a material with a low bulk modulus of elasticity such as a rubber material located within the communicating chamber 130. The material may be compressed by a high pressure spike in the fluid system 10 to absorb the energy of the high pressure spike. While the compliant member 140 is shown as a body with an annular cross-section, in other embodiments the compliant member may be any volume shaped such that it does not prevent the flow of fluid through the communicating chamber 130. In other embodiments, the compliant member may be coupled to the interior walls of the communicating chamber (e.g., a coating of a compliant material). A flow restriction device 124 may be a body with a small diameter bore disposed in the passage 132 between the hydraulic fluid system 10 and the communicating chamber 130.

The construction and arrangements of the hydraulic low-pass filter for pressure sensors, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A hydraulic low-pass filter for a pressure sensor, comprising:
a housing having an inlet and an internal fluid chamber configured to be filled with hydraulic fluid, the fluid chamber connected to a pressure sensor;
a flow restriction member provided between the inlet and the pressure sensor; and
a compliant member provided within the chamber;
wherein a cut-off frequency of the low-pass filter is a function of a size of a flow restriction applied by the flow restriction member and a compliance of the compliant member.

2. The hydraulic low-pass filter of claim 1, wherein the flow restriction member is configured to provide an adjustable flow restriction.

3. The hydraulic low-pass filter of claim 2, wherein the flow restriction member comprises an adjustable valve member and a seat, the valve member being moveable relative to the seat to selectively apply a specific amount of restriction to a fluid passage.

4. The hydraulic low-pass filter of claim 3, wherein the position of the valve member relative to the seat is adjustable by rotating the valve member.

5. The hydraulic low-pass filter of claim 4, wherein the cut-off frequency of the filter is adjusted by the adjustment of the flow restriction member.

6. The hydraulic low-pass filter of claim 1, wherein the fluid chamber comprises a main chamber, a first chamber extending from the main chamber, and a second chamber extending from the main chamber.

7. The hydraulic low-pass filter of claim 6, wherein the pressure sensor is threadibly received in the first chamber.

8. The hydraulic low-pass filter of claim 7, wherein the compliant member is provided in the second chamber.

9. The hydraulic low-pass filter of claim 8, wherein the compliant member comprises one of a Belleville washer, washers, or a compressible member.

10. The hydraulic low-pass filter of claim 9, wherein the compliant member is compressed by a moveable body.

11. An in-line low-pass filter for a hydraulic pressure sensor, comprising:
a housing having an inlet and an internal fluid chamber filled with hydraulic fluid, the fluid chamber coupled to a pressure sensor;
a flow restriction member provided between the inlet and the pressure sensor; and
a compliant member provided within the chamber;
wherein the low-pass filter is configured to filter high frequency noise and transient pressure spikes associated with a hydraulic device.

12. The hydraulic low-pass filter of claim 11, wherein the compliant member is disposed between the pressure sensor and the inlet.

13. The hydraulic low-pass filter of claim 12, wherein the compliant member comprises a rubber material.

14. The hydraulic low-pass filter of claim 13, wherein the compliant member is shaped such that it does not substantially impede the flow of fluid from the inlet to the pressure sensor.

15. The hydraulic low-pass filter of claim 11, wherein the flow restriction member is threadibly coupled to the inlet.

16. The hydraulic low-pass filter of claim 15, wherein the flow restriction device comprises a fixed orifice device.

17. A hydraulic system for mining equipment, comprising:
a hydraulic device;
a conduit containing hydraulic fluid coupled to the hydraulic device;
a hydraulic pressure sensor configured to sense the pressure of the fluid contained within the conduit; and
a low-pass filter disposed between the pressure sensor and the conduit, the low pass filter comprising:
a housing having an inlet and an internal fluid chamber filled with hydraulic fluid, the fluid chamber connected to the pressure sensor;
a flow restriction member provided between the inlet and the pressure sensor; and
a compliant member provided within the chamber;
wherein the low-pass filter is configured to filter high frequency noise and transient pressure spikes associated with the hydraulic device.

18. The hydraulic low-pass filter of claim 17, wherein the low-pass filter is adjustable to adjust a cut-off frequency of the low-pass filter.

19. The hydraulic low-pass filter of claim 18, wherein the pressure sensor converts pressure to an electrical signal.

20. The hydraulic low-pass filter of claim 18, wherein the pressure sensor is electrically coupled to a control system.
